(19) United States
(12) Patent Application Publication
(10) Pub. No.: US 2014/0167444 A1
(43) Pub. Date: Jun. 19, 2014

(54) VEHICLE SNOW & ICE REMOVAL SYSTEM/COVER

(71) Applicant: Richard C DiDato, South Salem, NY (US)

(72) Inventor: Richard C DiDato, South Salem, NY (US)

(21) Appl. No.: 14/126,100

(22) PCT Filed: Jun. 13, 2011
(86) PCT No.: PCT/US2011/040116

§ 371 Date: Feb. 4, 2014

Related U.S. Application Data
(60) Provisional application No. 61/354,201, filed on Jun. 12, 2010.

(51) Int. Cl. B60J 11/04

(52) U.S. Cl. CPC B60J 11/04
USPC 296/136.07

(57) ABSTRACT

A cover for a motor vehicle or other objects having a top surface and generally used or stored outdoors. The cover includes two sides that together substantially cover the top surface. The two sides meet along two barriers that extend perpendicularly upwards. Magnets, hook-and-loop fasteners and/or other fastening members are used to couple the two barriers together and to mount the sides to the objects. After a snow storm, the two sides are pulled laterally away from each other and then off the object. The barriers and the sides cooperate to drag and remove the snow from the top surface.

### BACKGROUND OF THE INVENTION

1. Field of Invention

This invention pertains to a cover for motor vehicles and other objects that splits into two parts so that it can be removed and thereby remove any snow and/or ice accumulated on the vehicle.

2. Description of the Prior Art

Various covers for motor vehicles are known for protecting them from harsh environment. However none of them are able to help a user to remove a heavy blanket of snow or ice.

The majority of the prior art focuses on allowing snow and ice to accumulate on a vehicle cover in one location or another but does not facilitate a proficient method of removing the snow and ice from a large area of a vehicle in a quick and efficient manner. For example, the cover seen in US Patent Application Publication 2005/0179281 A1) is designed only to protect a vehicle's windshield from snow and ice whereby the surface area of the said cover does not extend past the diameter of the windshield.

Other references known to the inventor are similarly deficient, including:

US 2007/0085372; U.S. Pat. No. 5,435,362; U.S. Pat. No. 5,653,492; and US 2005/0179281.

### SUMMARY OF THE INVENTION

I have invented a specialized vehicle cover which eliminates the need to brush and scrape snow and ice off of key areas on a vehicle which include the windshield, windshield washer spouts, roof, rear window, side windows, side view mirrors, and/or door handles. The cover includes attachments which extend the length of the vehicle cover to include the hood and the trunk if the said augmentation of the core invention is desirable by the user.

Importantly, the vehicle cover is divided into two separate sections longitudinally; however, the division of the vehicle cover, which forms the shape and size of each individual half of the cover, can be constructed in many variants including but not limited to asymmetrical designs. The two separate sections of the vehicle cover terminate with vertical barriers which attach to each other, via loop-and-hook type fasteners or other articulating mechanisms, at several points along the medial vertical barriers. Placing the two “connected halves” of the cover over a desired vehicle allows the snow to accumulate on the cover while keeping the vehicle underneath dry. Once the snow storm is over, each half of the snow cover is removed separately which allows the snow and ice to drop to the ground revealing a clean vehicle. In effect, the snow and ice removal from the aforementioned key areas is reduced to a simple two step process which includes first utilizing the handles to pull or separate one half of the snow cover from the other half and second repeating the action from step one to remove the snow ice from the other half of the vehicle by pulling the remaining half of the cover off of the vehicle.

### DESCRIPTION OF THE FIGURES

FIG. 1 is a three quarter view of the main invention 5 illustrating both sides 2A & 2B, disarticulated from each other, of the snow cover 5. Here one can see the vertical component or “barrier” 4A of the cover 5 being held in the upright position, at a 90° angle, by thin pieces of stiff material 6 on the lateral side of the barrier 4A. If necessary, L-shaped brackets or hinges may also be used to selectively hold barriers generally perpendicular to the respective sides. One can also see the top 10A and bottom 10B interfacing components which allow the medial side of the vertical wall 4B found on one half of the cover 2B to articulate with the medial side of the vertical wall 4A found on the other half of cover 2A. The handles 12 provide an easy mechanism for removing each half of the cover from the vehicle 28 & 45. Finally, the female components 22A & 22B, which provide an optional attachment for the length of the cover 5 to be extended to include the hood 40 and the trunk 41 of the vehicle 28 & 45, are visible as well. Also visible is a representation of a person/user 48 who would physically remove the cover 5 from the vehicle 28 & 45.

FIG. 2 is a top view of one half 2A of the snow cover 5 with the vertical barrier 4A laying flat against the body of the cover 5. Most of the same components from FIG. 1 are visible here. It's important to note that the vertical barriers 4A & 4B are of critical importance to all of the embodiments of the invention 5; if the vertical barriers 4A & 4B were not a component of the snow cover 5 each side 2A & 2B would slide under the snow 46 accumulation upon removal from the vehicle 28 & 45 leaving the snow 46 in its original place while not performing the intended utility of the invention 5.

FIG. 3 is a bottom view of one half 2A of the snow cover 5 revealing an anti-theft piece of material 16 which can be closed inside the door of the vehicle 28 & 45 to prevent the unwarranted removal of the cover 5.

FIG. 4 is a top view of the left 26A and right 26B side cover extensions which augment the size of the overall cover 5 to include the hood 40 and trunk 41 of the vehicle 45. This view also shows the male component 24A & B of a locking mechanism which allows each side of the cover extensions 26A & B to interface securely with the female component 22A & B of the locking mechanism found on the main cover 5.

FIG. 5 is a flowchart showing the cover extension segments 26A & 26B articulating with the body of the main cover 5 to extend its overall length.

FIG. 6 is a side view of a compact size vehicle 28 showing the invention 5 off and on the vehicle 28 without any snow 46 accumulation on its surface. Here you can also see how an antenna 36 located in the center of the vehicle's roof 38 do not interfere with one side 2A of the cover 5 articulating with the other side 2B of the cover 5. One can also see the handles 12 on the cover 5, which facilitate controlled gripping and pulling of each half 2A & 2B of the cover 5, and the narrow strings/straps 6 which anchor the top of the vertical barrier 4A to the body of the cover 5 to prevent it from moving past a 90° angle during the process of removing each half 2A & 2B of the cover 5 from the vehicle 28.

FIG. 7 is a front view of a compact size vehicle 28 showing the invention 5 off and on the vehicle 28 without any snow 46 accumulation on its surface. From this perspective one can see where the left half 2A of the cover 5 articulates with the right half 2B at the medial borders of both vertical barriers 4A & 4B, which forms a longitudinal seam running the length of the cover 5. Here it's easy to see the cover 5 extending far enough to protect all of the key areas of the vehicle 28. FIG. 8A is a side view flowchart showing a compact size vehicle 28 without the snow cover 5 in place, with the snow cover 5 in place on the vehicle 28 before precipitation 46 begins to fall, during a snowfall 46 event, and after the snow 46 has finished accumulating on the vehicle 28 and the surface of the cover 5.

FIG. 8B is the continuation of the flowchart from FIG. 8A depicting the user 48 removing the cover 5 from the vehicle 28 after the completion of the snowstorm 46. The first step has the user 48 gripping the handles 12 to separate and remove the first half 2A of the cover 5 from the vehicle 28; whereby, enabling the user 48 to dump the accumulated snow 46 and ice 46 from the surface of this half 2A of the cover 5 onto the ground without contaminating the vehicle 28 with the said frozen elements 46. The aforementioned process is then repeated on the other side of the vehicle 28 when the second half 2B of the cover 5 is removed from the said vehicle 28.

FIG. 8C is the continuation of the flowchart from FIG. 8B revealing a clean vehicle 28 free of snow 46 and ice 46 with the user 48 inside and ready to drive away.

FIG. 9 is flowchart showing a front view of a compact size vehicle 28 depicting the utilization of the invention 5 from the beginning to the end of a snow 46 event.

FIG. 10 is a top view of a midsized vehicle 45 showing first the vehicle 45 without the cover 49 in place and second with both sides 47A & 47B of the cover 49 in place on the vehicle 45. The first drawing shows some of the key areas of the vehicle 45 (including the trunk 41, rear window 43, roof 38, windshield 42, windshield washer spouts 44, hood 40, and side view mirrors 32) exposed before both sides 47A & 47B of the cover 49 are positioned to receive the snow 46 accumulation. The second drawing shows a top view of a midsized vehicle 45 with this embodiment of the invention 49, which extends further in length then the standard version 5, in place on the vehicle 45 to shield it from a pending snowstorm 46. With the cover 49 properly situated on the vehicle 45 all of the aforementioned key areas are protected from the accumulation of snow 46 and ice 46. This embodiment 49 of the invention precludes the need to attach separate extensions 26A & 26B to the body of the cover 49 since its length will encompass all or most of the vehicle's 45 hood 40 and truck 41.

FIG. 11 is flowchart showing a top view of a midsized size vehicle 45 depicting the utilization of the invention 49 from the beginning to the end of a snow 46 event.

FIG. 12 is a top view of a disposable embodiment 58 of the primary invention 5 designed to be used once and thrown away. The disposable snow cover 58 is manufactured with a perforated line 54 down the center of the material for easy separation of one side 50A of the cover 58 from the other side 50B after the snowstorm 46 is over. The vertical barriers 52A & 52B maintain their verticality when the disposable cover 58 is positioned on the vehicle 28 & 45 as a result of being attached to each other via a perforated line 54 in the plastic, having an extra layer of thickness to maintain their rigidity, and thin attachments 6 at the top and bottom of the vertical barriers 52A & B.

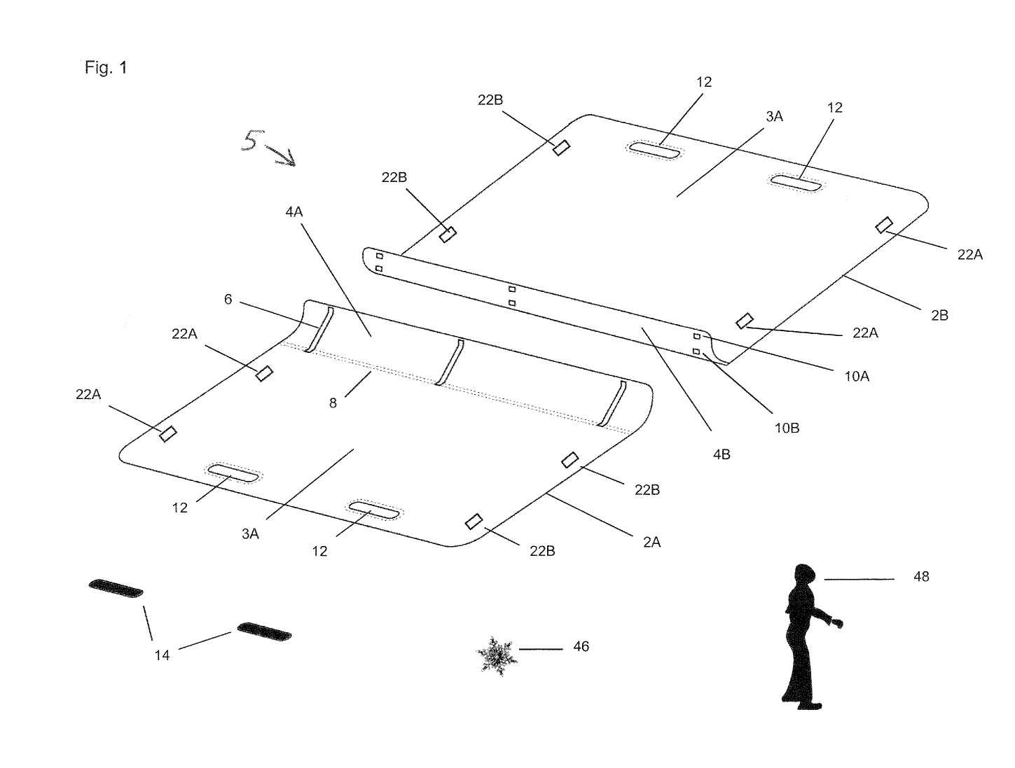

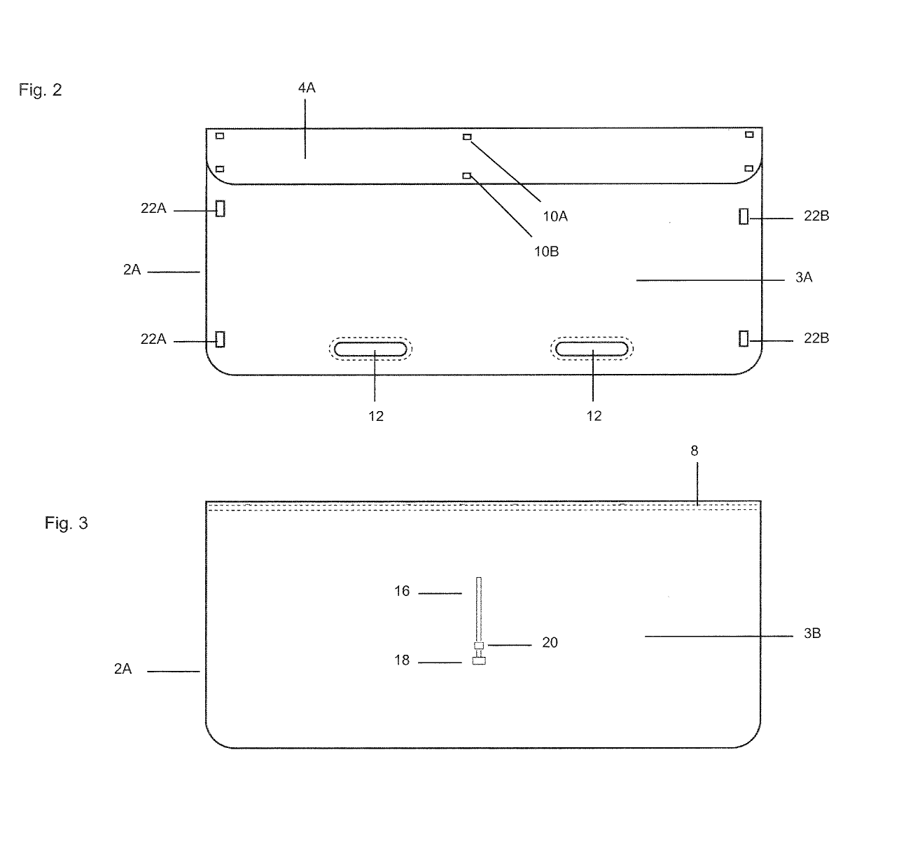

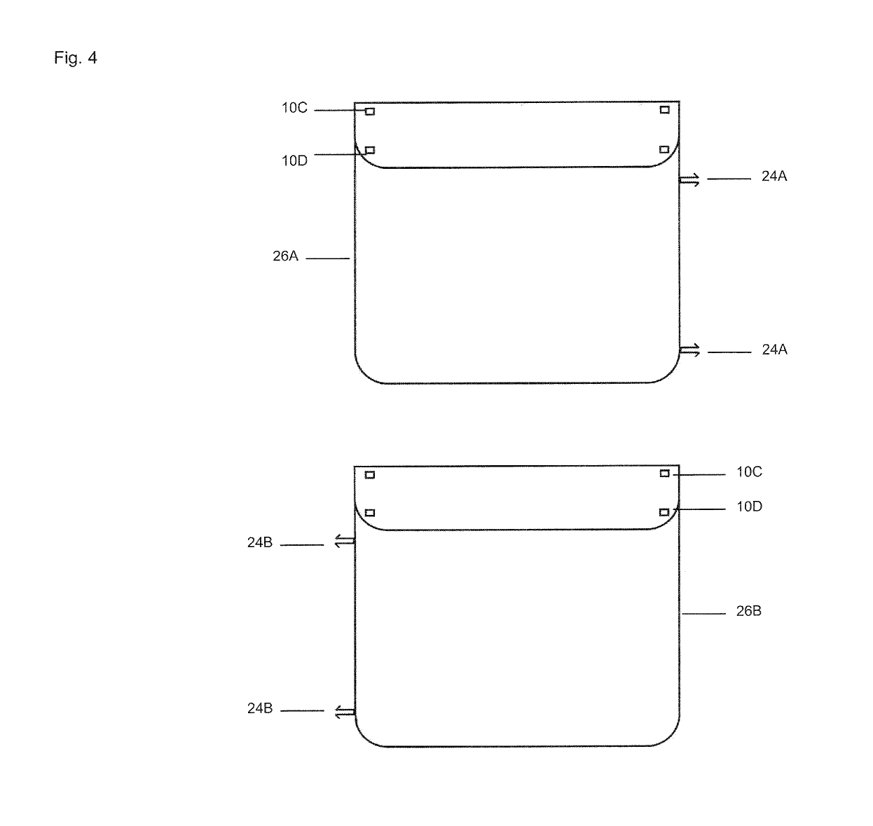

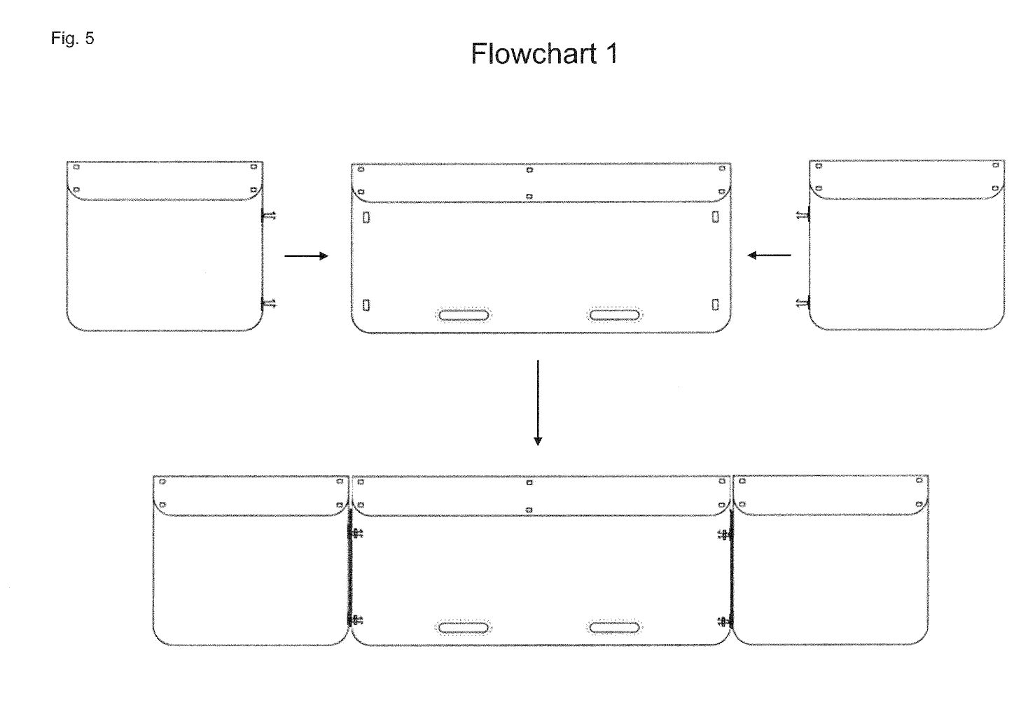

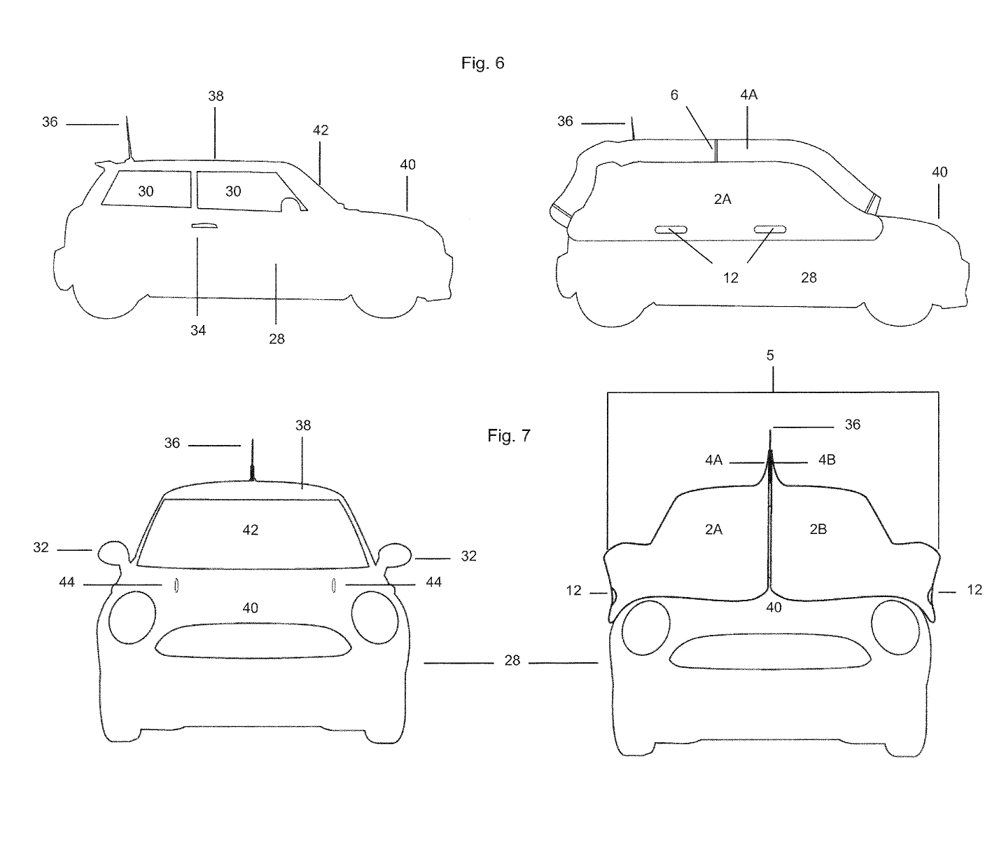

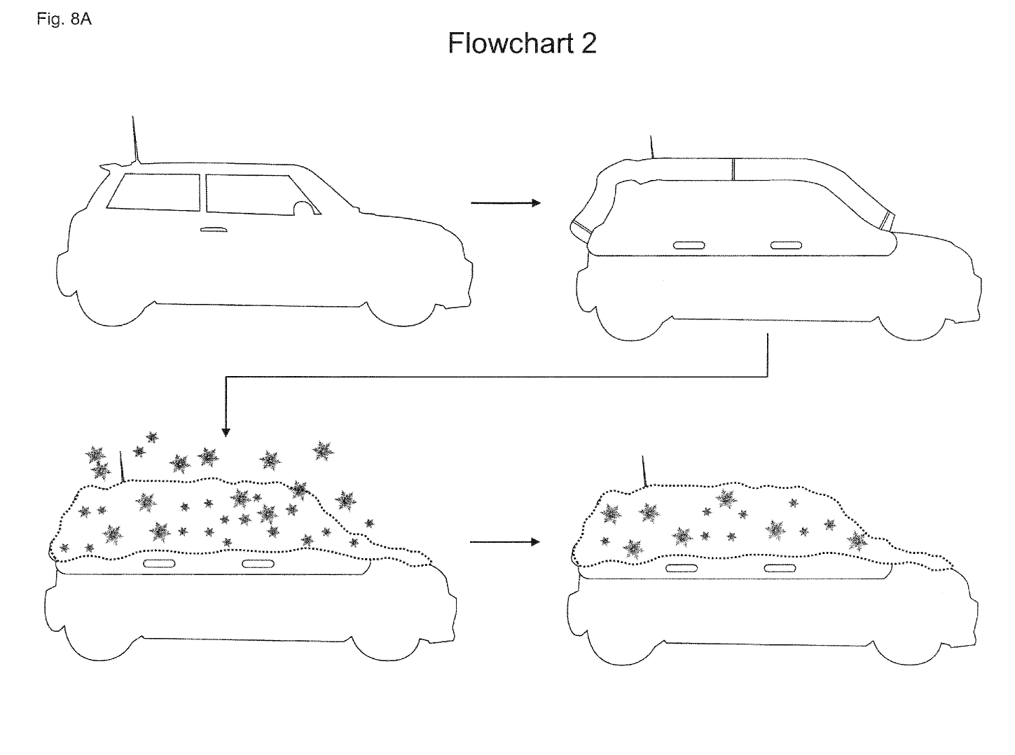

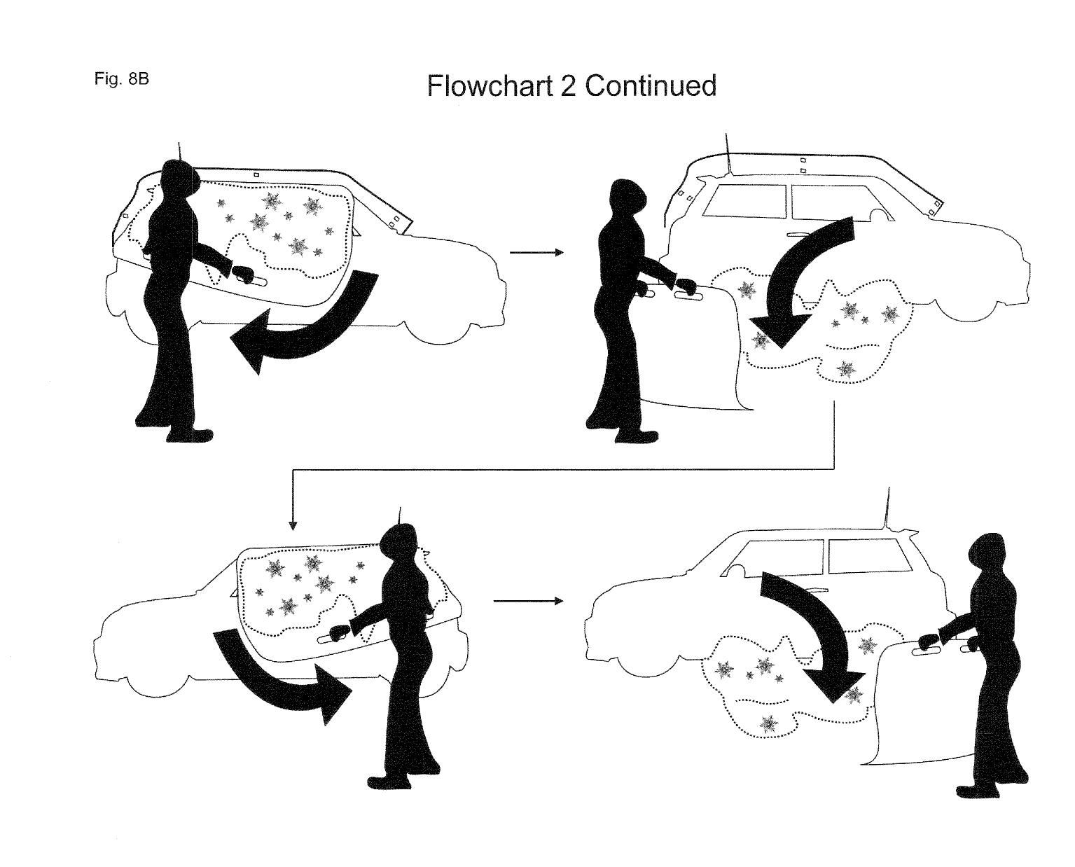

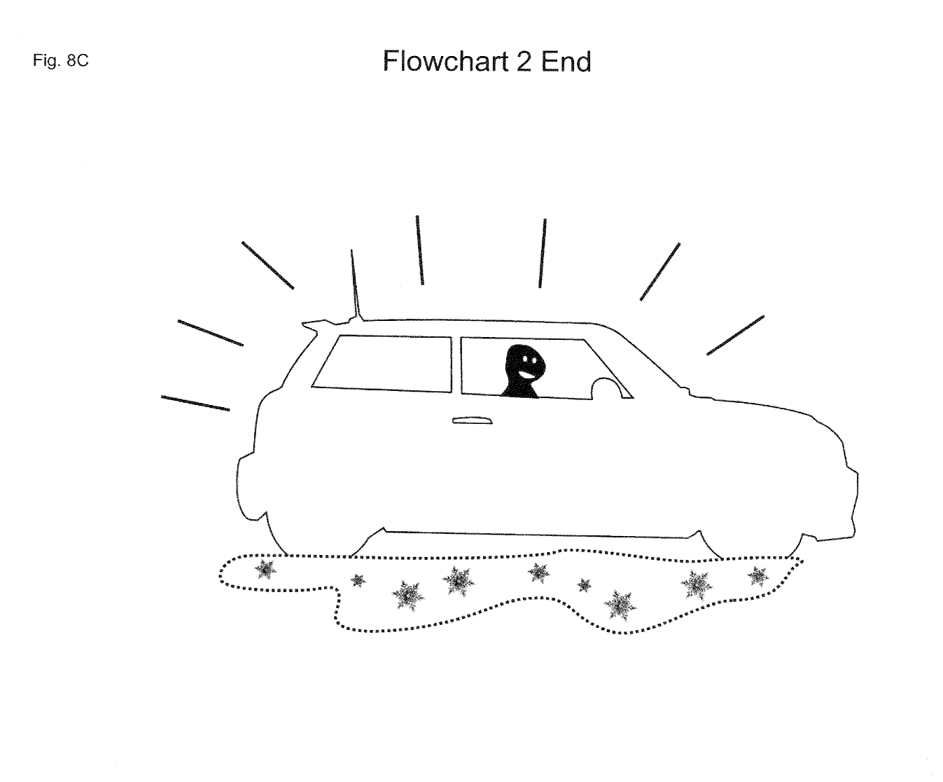

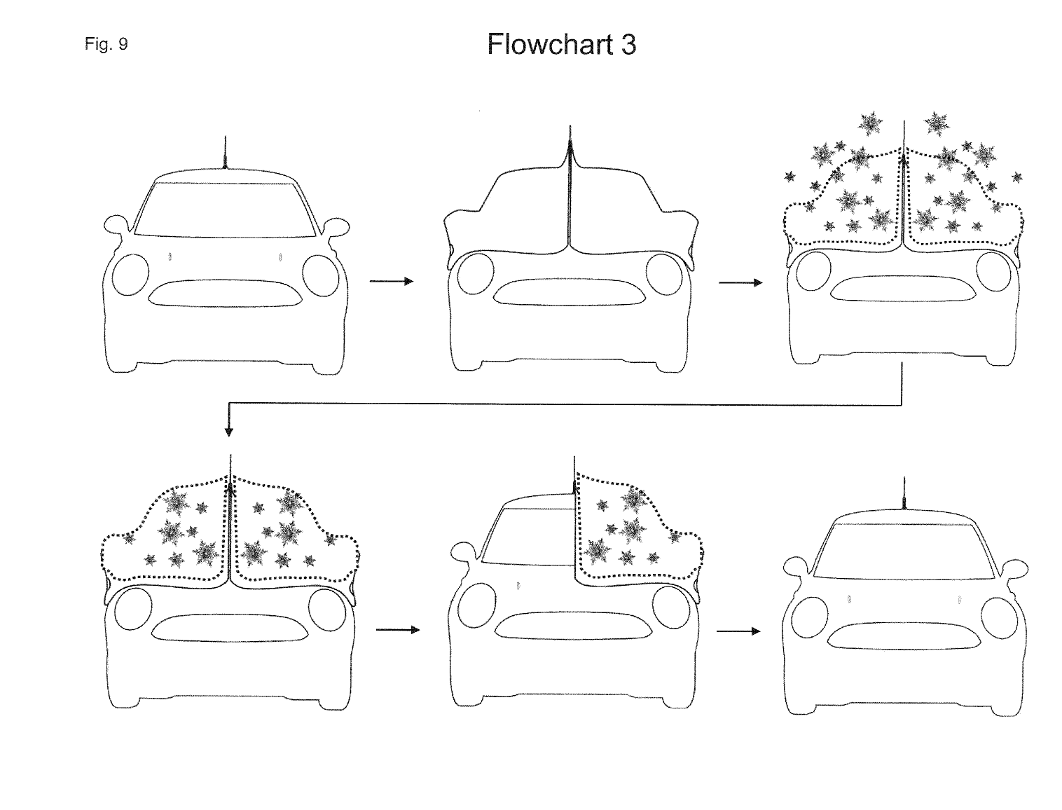

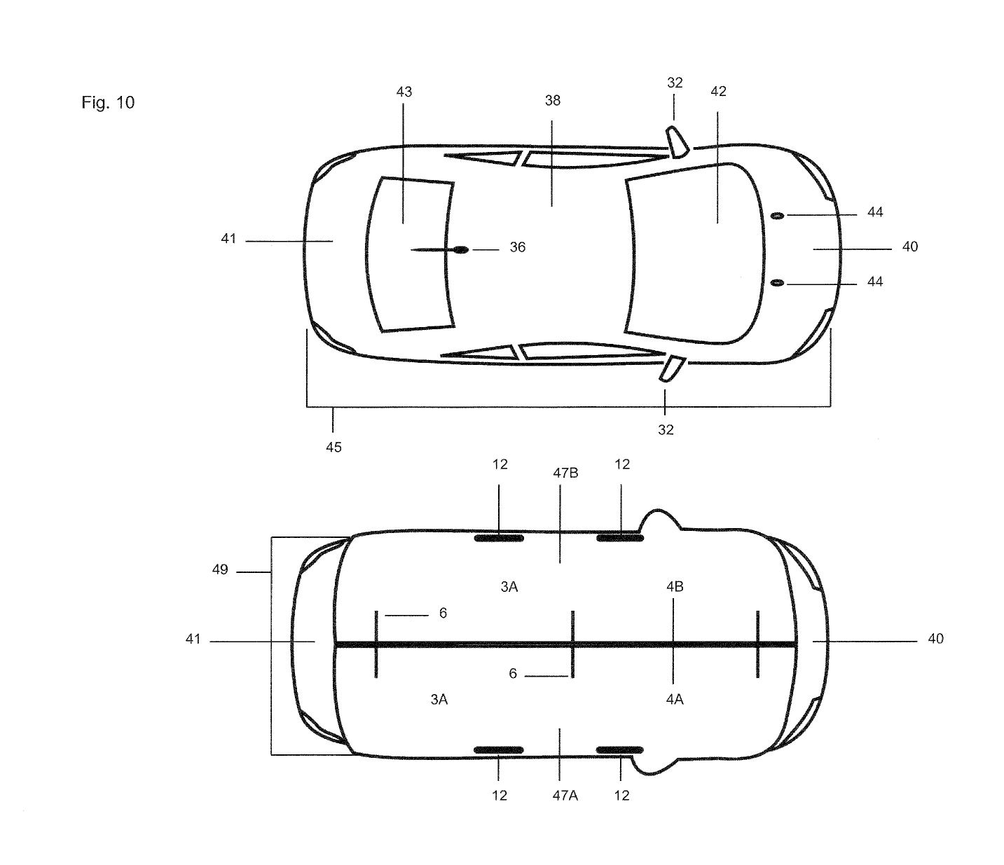

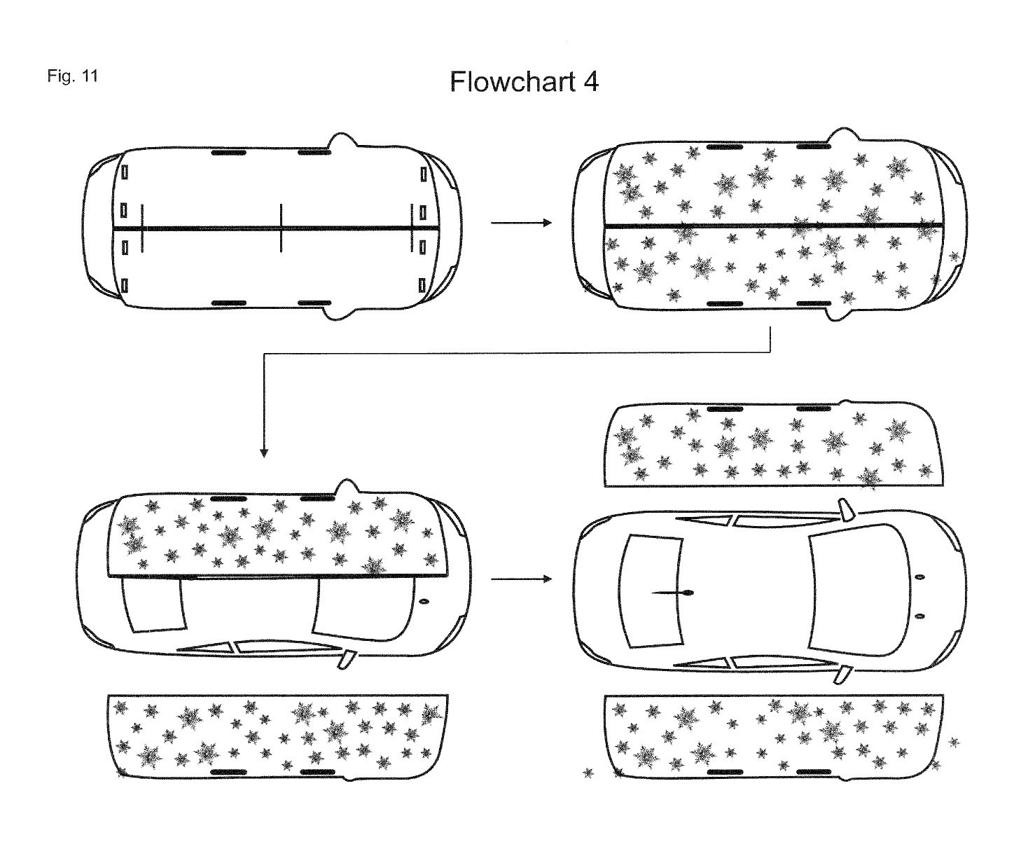

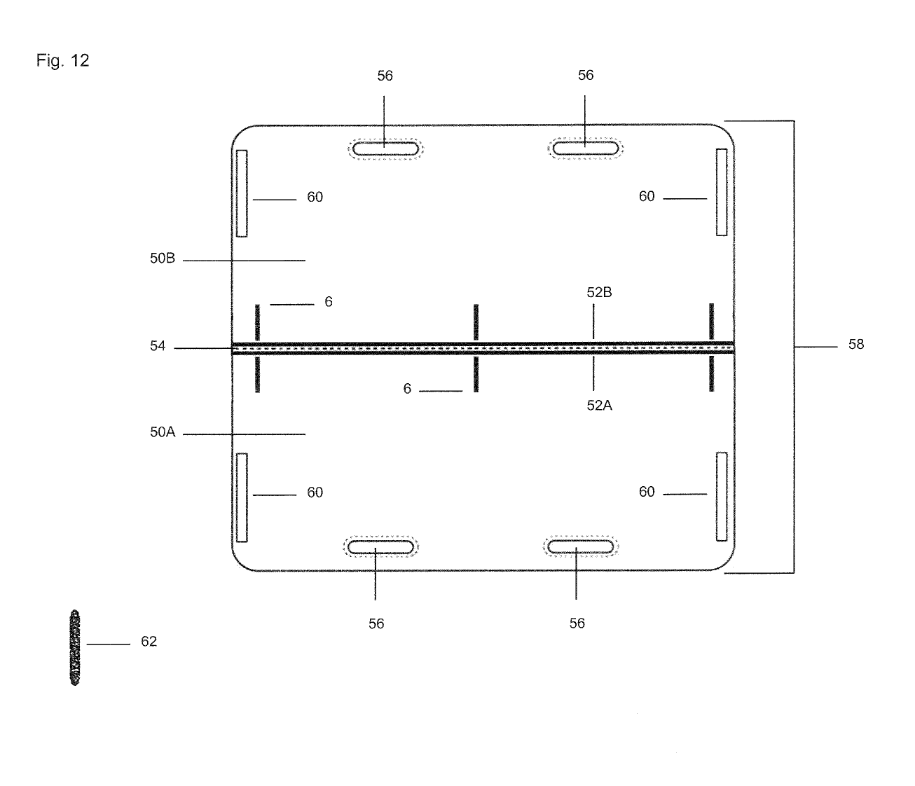

### DESCRIPTION OF THE PREFERRED EMBODIMENT

The components of my invention are:
2A is one half of the symmetrical vehicle cover 5.
2B is the other half of the symmetrical vehicle cover 5.
3A is the topside of the vehicle cover 5 which is constructed from weather proof material in order to prevent snow 46 and ice 46 from penetrating the cover 5.
3B is the bottom side of the cover 5 which is constructed from a nonabrasive material as to not scratch the vehicle 28 & 45 upon removal.
4A is the vertical component “barrier” of the vehicle cover 5 found on one half 2A of the cover.
4B is the same vertical “barrier” or component as found in 4A with the exception of being located on the other half 2B of the vehicle cover 5.
5 is the entire vehicle snow cover with one half 2A of the cover 5 attached to the other half 2B to form a whole or single cover 5 placed over the vehicle 28 & 45 to shield the key areas from snow 46 and ice 46.
6 is a piece of extra material or string which articulates at the top of the vertical barriers 4A & 4B and at their base to limit the range of the vertical component to 90°.
8 is stitching which denotes the base of the material which forms the vertical aspect 4A & 4B of the cover 5.
10A is the top row of a locking interface which allows the vertical barrier 4A found on one half of the cover 2A to attach to the vertical barrier 4B found on the other half of the cover 2B. The aforementioned locking mechanism 10A can be constructed out of male & female plastic pieces, Velcro, or other suitable types of material.
10B is the bottom row of a locking interface which allows the vertical barrier 10A found on one half of the cover 2A to attach to the vertical barrier 10B found on the other half of the cover 2B. The aforementioned locking mechanism 10B can be constructed out of male & female plastic pieces, Velcro, or other suitable types of material.
10C is the same as 10A except it's found on the cover extensions 26A & B and not on the vertical barriers 4A & B of the main cover 5.
10D is the same as 10B except it's found on the cover extensions 26A & B and not on the vertical barriers 4A & B of the main cover 5.
12 are handles which are hollow to accommodate magnets 14 which can be inserted and removed when necessary.
14 are magnets designed to fit inside the handles 12.
16 is rope or linear piece of material attached to a bulbous end 18 designed to add an anti theft element to the vehicle cover 5.
18 is the enlarged or extra layered end point of the rope 16.
20 is a Velcro loop which supports the rope 16 while the anti-theft extension is not being used.
22A is the female end of a locking component (located on the left side of the vehicle cover 5) which attaches to a male end of a locking component 24A found on a separate piece of the vehicle cover 26A designed to extend the cover's overall length to include the entirety of the hood 40 and the trunk 41.
22B is the female end of a locking component (located on the right side of each half of the vehicle cover 5) which attaches to a male end of a locking component 24B found on a separate piece of the vehicle cover 26B designed to extend the cover's overall length to include the entirety of the hood 40 and the trunk 41.
24A is the male end of locking components, found on the cover extension 26A, which articulate with the female locking components 22A found on the left side of the vehicle cover 5.
24B is the male end of locking components, found on the cover extension 26B, which articulate with the female locking components 22B found on the right side of the vehicle cover 5.
26A is an additional section of the vehicle cover designed to extend the main cover's 5 overall length to include the entirety of the hood 40 or trunk 41.
26B is an additional section of the vehicle cover designed to extend the main cover's 5 overall length to include the entirety of the hood 40 or trunk 41.
28 is a compact size vehicle.
30 are the side windows of a vehicle.
32 are the side view mirrors of the vehicle.
34 are the door handles of a vehicle.
36 is the roof antenna of a vehicle 28 & 45 which is located along the midline of the vehicle's roof 38.
38 is the roof of a vehicle.
40 is the hood of a vehicle.
41 is the trunk of a vehicle.
42 is the windshield of a vehicle.
43 is the rear window of a vehicle.
44 are the windshield washer spouts found on the hood 40 of a vehicle.
45 is a mid sized vehicle.
46 are snow and ice elements.
47A is one side or one half of the body of an alternative embodiment 49 of the core invention 5 which has an extended length to include most or all of the vehicles 45 hood 40 and trunk 41.
47B is the symmetrical other half of 47A.
48 is the person who would remove the cover from the vehicle after a snowstorm.
49 is both sides 47A & 47B of another embodiment of the snow cover with an extended length to shield all or most of the hood 40 and trunk 41 of the vehicle 45, which includes one half 47A of the cover attached to the other half 47B to form a whole or single piece 49.
50A is one side or one half of the body of a disposable embodiment 58 of the invention designed for a single use. The material used for the disposable version 58 will most likely be plastic but is not limited to the said material.
50B is the symmetrical other half of 50A.
52A is the vertical barrier found on the medial border of one half 50A of the disposable version 58 of the invention. The vertical barriers 52A & B found on the disposable embodiment 58 of the cover will be at least 6″ in height.
52B is the vertical barrier found on the medial border of the other half 50B of the disposable embodiment 58 of the invention.
54 is a line perforation attaching one vertical barrier 52A to the other 52B at the top and bottom to ensure the barriers maintain their verticality.
56 are the handles found on the disposable version of the invention 58.
58 is the entire disposable snow cover, which includes one half 50A of the cover attached to the other half 50B to form a whole or single piece.
60 are pockets on the disposable embodiment of the cover 58 which hold sand like material in a removable pouch 62.
62 is a pouch or sealed piece of material containing sand or similar substance for the purpose of weighing down the corners of the disposable cover 58.

Basic components of the sides and barriers include: Water, ice, and snow proof material; such as a vinyl, plastic, synthetic materials or any of the many options which exist to prevent water & snow from passing through the material. Soft breathable material like cotton or many other materials with can be used not to scratch the vehicle during the removal of the cover. Velcro, magnets, plastic, string or rope may also be of use in manufacturing the vehicle cover to selectively attach the sides to each other and/or the motor vehicle as described.

Thus, I have invented a specialized vehicle cover 5 which eliminates the need to brush and scrape snow 46 and ice 46 off of key areas on a vehicle 28 & 45 which include the windshield 42, windshield washer spouts 44, roof 38, rear window 43, side windows 30, side view mirrors 32, and door handles 34. I've also invented attachments 26A & 26B which extend the length of the vehicle cover 5 to include the hood 40 and the trunk 41 if the said augmentation of the core invention 5 is desirable by the user 48.

To achieve these results I′m using a specialized vehicle cover 5 which is divided into two separate sections 2A & 2B longitudinally; however, the division of the vehicle cover 5, which forms the shape and size of each individual half 2A & 2B of the cover 5, can be constructed in many variants including symmetrical as well as asymmetrical designs. The two separate sections 2A & 2B of the vehicle cover 5 attach to each other, via Velcro™ 10A & 10B or other articulating mechanisms like the male 24A and female 22A ends of a snap lock, at several points along the medial vertical barriers 4A & 4B of each half 2A & 2B of the cover 5 to form a single piece of material/cover 5. Placing the two “connected halves” 2A & 2B of the auto snow cover 5 over a desired vehicle 28 & 45 allows the snow 46 & ice 46 to accumulate on the cover 5 while keeping the vehicle 28 & 45 underneath dry. Once the snow 46 storm is over, each half 2A & 2B of the snow cover 5 is removed separately which pulls the snow 46 & ice 46 to drop to the ground revealing a clean windshield 42, roof 38, rear window 43, side windows 30, and side view mirrors 32, door handles 34, and windshield washer spouts 44. In effect, the snow 46 and ice 46 removal from the aforementioned key areas is reduced to a simple two step process which includes first utilizing the handles 12 to pull or separate one half 2A of the snow cover 5 from the other half 2B and second repeating the action from step one to remove the snow 46 & ice 46 from the other half of the vehicle 28 & 45 by pulling the remaining half 2B of the cover 5 off of the vehicle 28 & 45.

The invention 5 has a vertical fin 4A & 4B or “barrier” type of component which can range from 4″ to 12″ inches in height and runs the length of the medial borders of both halves 2A & 2B of the vehicle snow cover 5. This vertical element 4A & 4B of the invention 5 assists in “pulling” all of the snow 46 & ice 46 off of one side of the vehicle 28 & 45 while the first half 2A of the cover 5 is being removed and then the same action is initiated on the other side of the vehicle 28 & 45 to complete the process. The “fin” 4A & 4B holds its vertical position at a 90° angle and does not fall backward to the same parallel flat plane of the cover 5. The vertical position of the barriers 4A & 4B is maintained by attaching one half 2A of the vehicle cover 5 at key locations, via male & female forms of articulation 10A & 10B, to the other half 2B along the medial borders of both sides 2A & 2B of the cover 5. The important areas for the male and female articulations 10A & 10B to interface are at the top and bottom of the “fin” or vertical barriers 4A & 4B of the snow cover 5 (this is on the medial side of each vertical barrier 4A & 4B). After a snowstorm, one half 2A of the cover 5 is separated from the other half 2B, as each side of the cover 5 is pulled from the vehicle 28 & 45, yet the vertical barriers 4A & 4B do not move past their 90° range of motion by being tied down, via thin strings or pieces of material 6, from the top of the barriers 4A & 4B to the body of the car cover 5 at several locations (this is on the lateral side of each vertical fin 4A & 4B). If necessary, extra material, hinges, or brackets can be added to the barriers 4A & 4B which facilitates a suitable level of rigidity to help maintain the vertical position of the barrier 4A & 4B while the cover 5 is situated on a vehicle 28 & 45 in preparation of a snowstorm 46. When the vehicle cover 5 isn't in use the vertical barriers 4A & 4B can fold over, laterally, to lay flat against the cover 5 for easy storage. The attachments 10A & 10B between the medial side of the two vertical barriers 4A & 4B are strong enough to hold the two sides 2A & 2B of the cover 5 together while they're on the vehicle 28 & 45, in preparation of a snowstorm 46, while at the same time being weak enough to separate easily from each other after the snowstorm 46. The vertical barriers 4A & 4B, which act to force the snow 46 off of the vehicle 28 & 45 when each side 2A & 2B of the cover 5 is removed, can be perforated with holes or formed out of a net/mesh type of material which allow wind to pass through the vertical barriers 4A & 4B and thereby not move the cover 5 significantly out of its optimal position on the vehicle 28 & 45. Once the snow 46 begins to accumulate on the said vehicle 28 & 45 the cover 5 is less inclined to move out of preferred position from wind.

The invention utilizes two handles 12, constructed from the material of the vehicle cover 5 or something similar, for easy gripping while the user is pulling or removing each half 2A & 2B of the cover 5 from the vehicle 28 & 45. The handles 12 are hollow and have openings which accommodate magnets 14 for the purpose of securing each half 2A & 2B of the car cover 5 to the vehicle 28 & 45 during wind storms. Once the magnets 14 are inserted into the handles 12 the added rigidity makes the handles 12 easier to grip while each half 2A & 2B of the cover 5 is being removed from the vehicle 28 & 45. The handle 12 opening, for the magnets 14, can be sealed and reopened to prevent the magnets 14 from falling out while they're not attached to the side of the vehicle 28 & 45. The front and back sides of the cover 5 are weighted to hold down the cover 5 on the hood 40 and trunk 41 during high winds. The weighted ends of the cover 5, which keep the wind from moving it out of place on the hood 40 and trunk 41 of the vehicle 28 & 45, may or may not be removable.

The invention 5 uses nonabrasive materials on the bottom side 3B to ensure no aspect of the vehicle 28 & 45 is scratched while the specialized snow cover 5 is being removed. Also, the topside 3A of the cover 5 will be constructed from a weather proof material to prevent water, snow 46, and ice 46 from migrating to the surface of the vehicle 28 & 45.

Since the invention 5 is two separate halves 2A & 2B articulating at the midline of the vehicle 28 & 45 to form a single cover 5 any objects located at the centerline of the vehicle's roof 38 will not be affected by or effect the performance of the snow cover 5. One half 2A of the cover 5 simply connects to the other half 2B while keeping objects like roof antennas 36 or similar objects between the articulation points 10A & 10B, found on the medial side of each vertical barrier 4A & 4B.

The invention 5 is designed to fold up in a compact neat form, where the vertical barriers 4A & 4B lay flat against the body of the cover 5, so it can be stored easily once it has been removed from the vehicle 28 & 45.

The invention 5 can also be augmented to cover all or most of the vehicle's hood 40 and trunk 41 as well by including female points of articulation 22A & B at the front and back of the cover 5. When the aforementioned female components 22A & B are connected to male articulating components 24A & B, which are located on separate extensions of material 26A & B, the length of the primary snow cover 5 extends to encompass the entirety of the hood 40 and trunk 41. Note, all embodiments of the invention 5 prevent or limit snow 46 & ice 46 from accumulating on the doors of the vehicle 28 & 45.

Conversely, another embodiment 49 of the invention 5 eliminates the need to use cover extensions 26A & 26B and their points of articulation 22A & B in favor of extending the overall length of the cover 49 to include all or most of the hood 40 and the trunk 41 of the vehicle 45.

Each embodiment of the invention 5 can be manufactured out of different materials (i.e. soft fabrics, vinyl, polyester, plastics or any variant of such materials or other materials which haven't been mentioned) depending on the desired purpose and utilization of said materials. For example, a more expensive version of the invention 5 could be designed to “breath” so it can stay on a vehicle 28 & 45 for long periods of time. In contrast, an inexpensive version of the invention 5 could be designed to stay on the vehicle 28 & 45 for only the duration of a single snow 46 storm. To further illustrate this point there could be disposable plastic version 58 of the snow cover which is designed to be used once and then thrown away.

Lastly, the value and utility of the invention 5 doesn't end with vehicles 28 & 45; it can also be used on various outdoor items like tables and other large objects which may require snow 46 removal.

The method or arrangement for these components includes combining various layers of specialized material which provide for a nonabrasive bottom side and a weather proof top side.

The snow cover 5 also has locking components 22A & 22B on its surface 3A to accommodate cover extensions 26A & 26B if the user desires a greater surface area of protection on the vehicle 45.

The snow cover 5 achieves its result as follows: One half 2A of the cover 5 is connected to the other half 2B along their medial vertical borders 4A & 4B via plastic inter-locks 10A & 10B or Velcro strips at specified locations. This articulation occurs at the top 10A and bottom 10B of the vertical barriers 4A & 4B of the cover 5, which runs the length of the medial borders on both sides 2A & 2B of the snow cover 5. Then, with both halves 2A & 2B of the cover 5 articulated together, the entire cover 5 is positioned on top of the vehicle 28 & 45 as one piece. This prevents snow 46 & ice 46 from building up on key areas of the vehicle 28 & 45 including the windshield 42, windshield washer spouts 44, roof 38, rear window 43, side windows 30, side view mirrors 32, and door handles 34.

After the storm is complete, the vehicle cover 5 is removed in two steps (one side at a time) when the user 48 holds the handles 12 found on the cover 5 to pull the accumulated snow 46 & ice 46 off of the vehicle 28 & 45 revealing a clean vehicle 28 & 45 underneath.

There are other ways to implement a snow cover for vehicles 28 & 45 which may not be as effective as the primary invention 5 yet still provide methods of snow and ice 46 removal. In one alternate embodiment, the snow cover uses two symmetrical halves, however, the halves do not articulate with each other at their medial intersection. Instead, each side of the cover is positioned on the vehicle separately while overlapping one another to shield the aforementioned key areas from the frozen elements.

I claim:

1. A snow cover for protecting a top surface of an object, said snow cover comprising:
a cover body formed of two sides extending substantially covering said top surface, each side including a barrier rising essentially perpendicularly upward with respect to said sides; and
coupling members coupling said barriers together, said coupling members being arranged to selectively separate and allow said sides to be pulled off from said top surface.

2. The cover of claim 1 wherein said sides are sized and shaped to cover a motor vehicle.

3. The cover of claim 2 wherein said motor vehicle includes said top surface, a windshield, trunk top surface and a motor top surface, and each said side includes a first portion partially covering said top surface and a second portion partially covering at least one of said windshield, said trunk top surface and said motor top surface.

4. The cover of claim 1 further comprising mounting members for mounting said sides to the object.

5. The cover of claim 1 wherein said coupling members and said mounting members are one magnets, strings and hook and loop fasteners.

6. The cover of claim 1 wherein said sides have the same size and shape.

7. The cover of claim 1 wherein said object includes a longitudinal axis and said sides are disposed in parallel to said longitudinal axis.

8. The cover of claim1 wherein said object has a transversal axis and said sides are disposed in parallel to said transversal axis.

9. The cover of claim 1 wherein said sides include handles used to separate said sides and pull them off from the object.

10. The cover of claim 1 wherein said barrier have height in the range of 2-8″.
